(19) United States
(12) Patent Application Publication
(10) Pub. No.: US 2006/0169010 A1
(43) Pub. Date: Aug. 3, 2006

(54) Blocking device for a motor vehicle steering shaft

(76) Inventor: Hans-Joachim Limburg, Schwabhausen (DE)

Correspondence Address: BACON & THOMAS, PLLC, 625 SLATERS LANE, FOURTH FLOOR, ALEXANDRIA, VA, 22314, US

(21) Appl. No.: 10/548,319

(22) PCT Filed: Apr. 21, 2004
(86) PCT No.: PCT/EP04/04219

§ 371 Date: Sep. 7, 2005

(30) Foreign Application Priority Data
May 6, 2003 (DE) 103 20 154.8

(51) Int. Cl. B60R 25/02

(52) U.S. Cl. 70/186

(57) ABSTRACT

A device for locking a motor vehicle steering shaft against rotation by means of a locking bolt which cooperates with locking recesses of the steering shaft and which can be displaced back and forth, between a locking position and a release position by means of a control member which can be rotated to-and-fro by an electric motor and which cooperates with a rotary position detector. To maintain the device as compact as possible, the control member is shaped as a circular control disk which cooperates on one side with the locking bolt and on the other side with the rotary position detector.

The invention relates to a device for locking the steering shaft of a motor vehicle against rotation by means of a locking bolt, which cooperates with locking recesses of the steering shaft and which can be displaced back and forth between a locking position and a release position with the aid of a control member that can be rotated back and forth by an electric motor and which cooperates with a rotary position detector.

Such devices for locking the steering shaft of a motor vehicle so that it can no longer be rotated are known in various versions.

In one such known device for locking the steering shaft of a motor vehicle against rotation, the control member has an eccentric in order to cooperate with the locking bolt that is urged into the steering shaft locking position by a helical compression spring, and the control member is connected in a manner fixed against relative rotation to the output gear wheel of a reduction gearing located downstream of the electric motor. The two rotary positions of the control member, associated respectively with the steering shaft locking position and the steering shaft release position of the locking bolt, are defined with the aid of two contactless switches or two microswitches, with which the output gear wheel of the reduction gearing cooperates and which are part of an electronic control circuit by which the electric motor, an alarm device that becomes operative in the event of improper motion of the locking bolt from the locking position to the release position, and the ignition and the starter of the motor vehicle engine are all controlled (U.S. Pat. No. 4,643,009).

In another known device for locking the steering shaft of a motor vehicle against rotation of the kind being discussed, the control member has a helically extending outer lifting cam for moving the locking bolt that extends parallel to the axis of rotation of the control member. The control member, behind the end of the locking bolt facing away from the steering shaft, also has circumferential teeth which are engaged by a worm seated on the output shaft of the electric motor. The control member cooperates beside the circumferential teeth on their side facing toward the lifting cam and the locking bolt, with an electric limit switch in order to stop the control member after one revolution (German Patent Application DE-A 100 22 830).

In two other known devices for locking the steering shaft of a motor vehicle against rotation of the type defined above, the control member is provided with a helically extending inner or outer lifting cam for moving the locking bolt which is located coaxially with or parallel to the axis of rotation of the control member, which is also provided with circumferential teeth, which are engaged by a worm seated on the output shaft of the electric motor, or by the output gear wheel of a spur gearing located downstream of the electric motor. Between the circumferential teeth and the other end of the control member, or the outer lifting cam of the control member, electrical limit switches or switch elements (snap switches and/or microswitches) for detecting various rotary positions of the control member are distributed about the axis of rotation of the control member and are actuated by means of suitable cams on the control member (German Patent Application DE-A 101 33 408).

The object of the invention is to create a device of the type defined at the beginning which is distinguished by the greatest possible compactness and hence the least possible space requirement.

This object is attained according to the invention by the features recited in the characterizing portion of claim 1. Advantageous improvements of the device of the invention are disclosed in the remaining claims.

Below, one preferred embodiment of the device according to the invention for locking the steering shaft of a motor vehicle against rotation is described as an example, in conjunction with drawings. In the drawings:

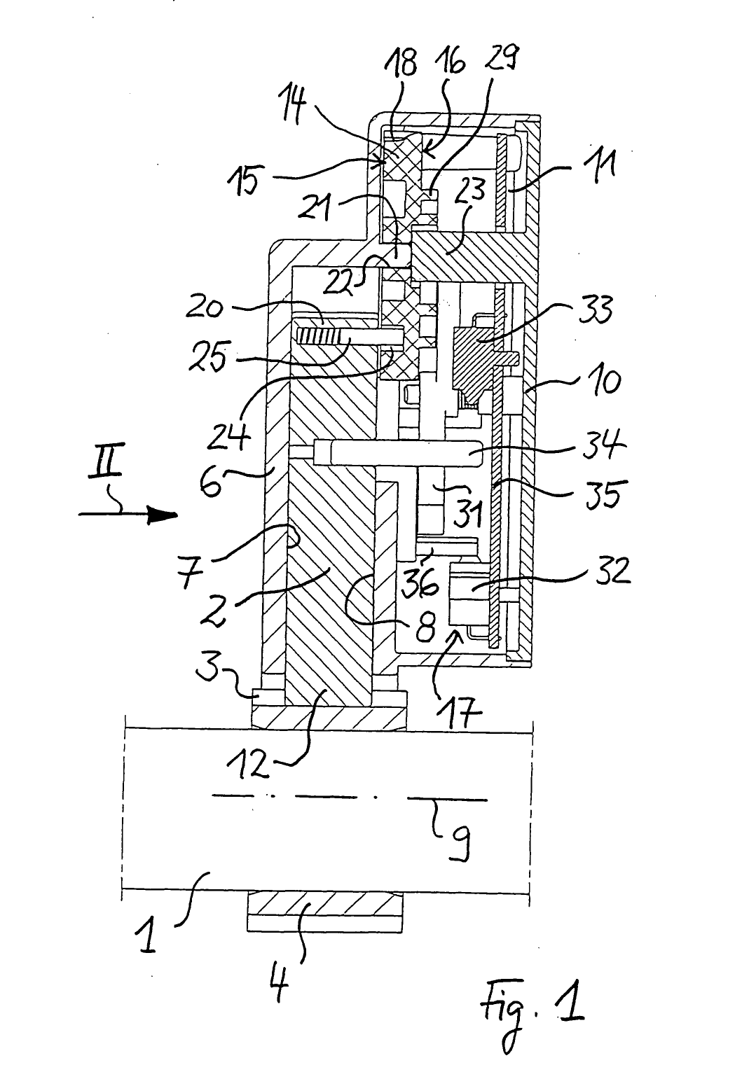

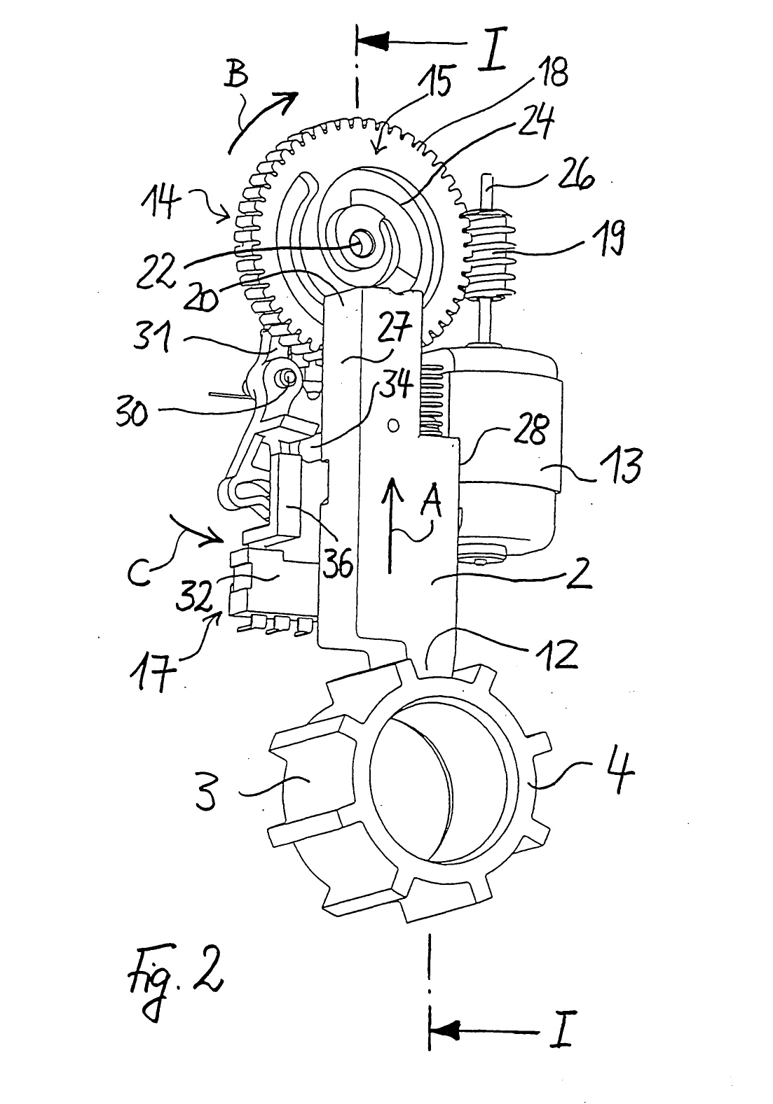

FIG. 1 shows a longitudinal section along the line I-I in FIG. 2, in which the locking bolt is in its locking position;

FIG. 2 is a view in the direction of the arrow II in FIG. 1, without the housing, housing cap and printed circuit board and without the steering shaft, in perspective;

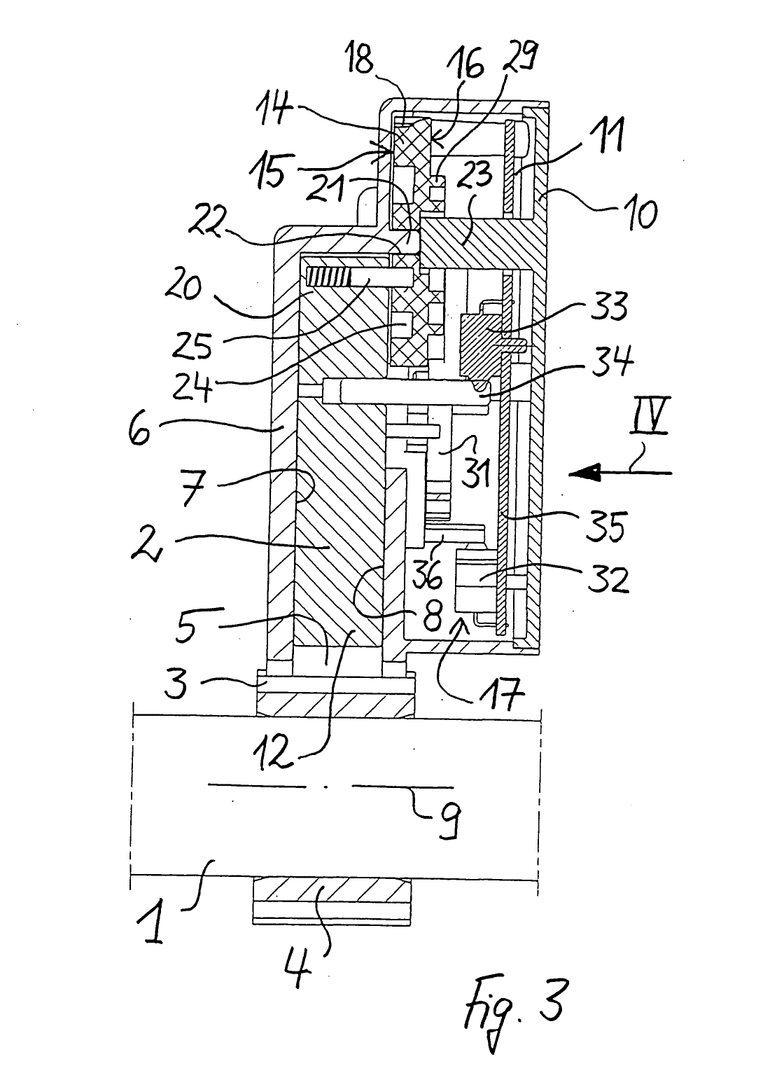

FIG. 3 is the longitudinal section of FIG. 1, in which the locking bolt is in its release position;

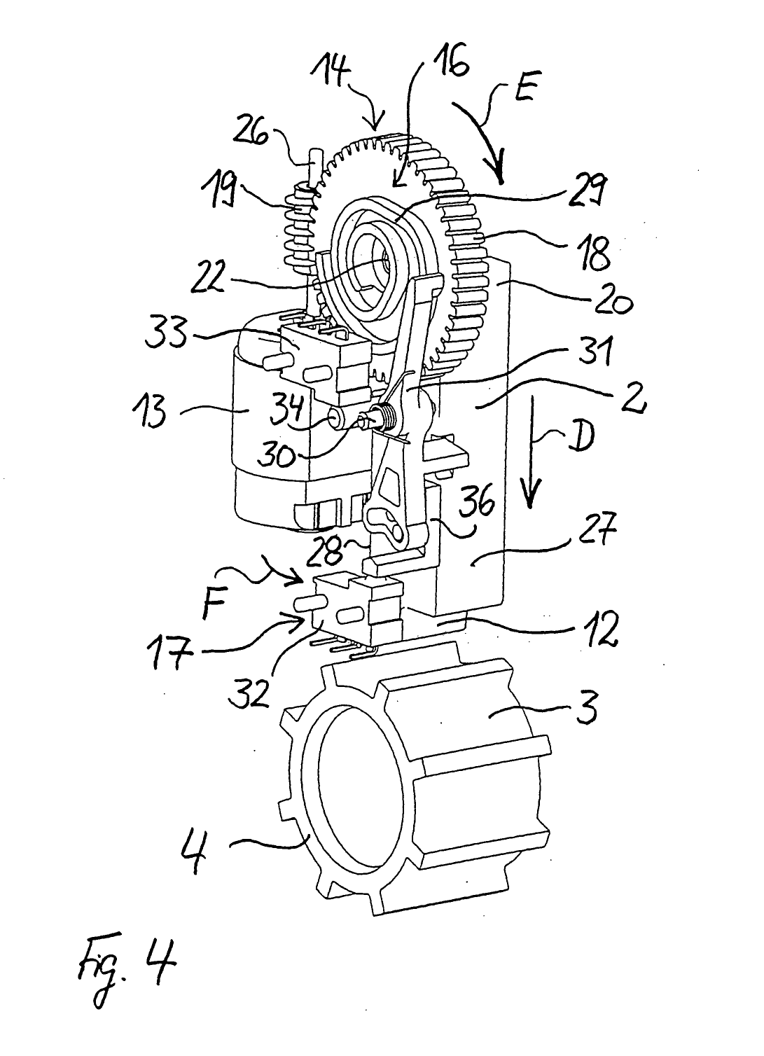

FIG. 4 is a view in the direction of the arrow IV in FIG. 3, without the housing, housing cap and printed circuit board and without the steering shaft, in perspective;

FIG. 5 is a perspective view of the side of the control disk provided with a spiral groove;

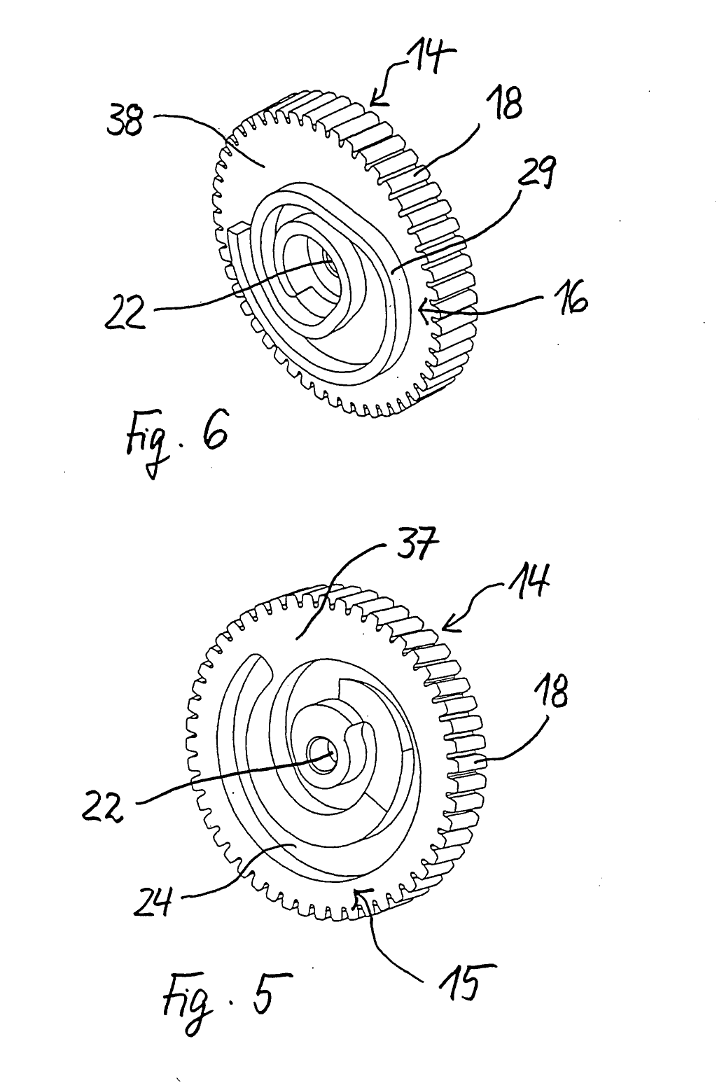

FIG. 6 is a perspective view of the side of the control disk provided with a spiral rib.

The device shown for locking the steering shaft 1 of a motor vehicle against rotation includes a locking bolt 2, which cooperates with groovelike locking recesses 3 of a locking sleeve 4 secured to the steering shaft 1. The steering shaft 1 and the locking sleeve 4 are surrounded by a tubular housing, not shown, with a through opening for the locking bolt 2.

The locking bolt 2 has a rectangular cross section and is supported axially displaceably in a duct, 5 of corresponding cross section of a housing 6. The two broader side faces 7, 8 of the duct 5 each extend in a plane that is perpendicular to the common longitudinal axis 9 of the steering shaft 1 and of the tubular housing thereof that extends coaxial with it. On the side remote from the duct 5, the housing 6 is provided with a mounting opening 11, closed by a cap 10, and the housing 6 is secured to the tubular shaft housing.

The locking bolt 2 is movable back and forth between the locking position, visible in FIGS. 1, 2, where, with its end 12 facing toward the steering shaft 1, it engages a locking recess 3 of the locking sleeve 4, so that the steering shaft 1 can no longer be rotated, and the release position, visible in FIGS. 3, 4, where the locking bolt 2, with the end 12, does not engage any locking recess 3 of the locking sleeve 4 and releases the steering shaft 1, so that it can be rotated.

For axial displacement of the locking bolt 2 into the release position and in the opposite direction into the locking position, a circular control disk 14 is used, which can be rotated back and forth by means of an electric motor 13 with reversible direction of rotation. The control disk 14 cooperates on one side 15 with the locking bolt 2 and on the other side 16 with a rotary position detector 17 and has circumferential teeth 18, which are engaged by a worm 19 driven by the electric motor 13.

On the side of the locking bolt 2 facing toward the housing cap 10, the control disk 14 is located next to the end 20 of the locking bolt 2 remote from the steering shaft 1 and the control disk 14 is supported rotatably in the housing 6 on a cylindrical protrusion 21 of the housing 6, which engages a central bearing bore 22 of the control disk 14 and extends perpendicular to the two broader side faces 7, 8 of the duct 5 of the housing 6, guiding the locking bolt 2. The control disk 14 is axially fixed on the cylindrical protrusion 21 of lesser diameter by means of a cylindrical protrusion 23 of greater diameter of the housing cap 10.

On the side 15 adjacent to the locking bolt 2, the control disk 14 is provided with a spiral groove 24 which winds around the bearing bore 22 of the control disk 14, and which is engaged by a cylindrical pin 25 protruding laterally from the locking bolt 2 on its end 20 remote from the steering shaft, so that upon rotation of the control disk 14 in one direction or the other, the locking bolt 2 is axially displaced in one direction or the other radially relative to the axis of rotation of the control disk 14 which axis is defined by the housing protrusion 21.

The worm 19 that engages the circumferential teeth 18 of the control disk 14 is secured to the output shaft 26 of the electric motor 13. The electric motor 13 is disposed in the housing 6 next to the locking bolt 2, so that its output shaft 26 extends parallel to the two narrower side faces 27, 28 of the locking bolt 2.

On the side 16 remote from the locking bolt 2, the control disk 14 is provided with a protruding spiral rib 29, which winds around the bearing bore 22 of the control disk 14 and cooperates with the rotary position detector 17, namely via a spring-loaded, two-armed pivot lever 31 which is pivotable in the housing 6 about an axis 30 extending parallel to the housing protrusion 21, and which cooperates with an electric switch 32 in order to actuate the switch 32 both at the rotary position of the control disk 14 corresponding to the locking position of the locking bolt 2 and at the rotary position of the control disk 14 corresponding to the release position of the locking bolt 2. A further electric switch 33 is actuated by a pinlike lateral protrusion 34 of the locking bolt 2 when the locking bolt 2 assumes its release position. The two electric switches 32, 33 are disposed on a printed circuit board 35, which is mounted in the housing 6 and which extends parallel to the housing cap 10.

The mode of operation of the device described for locking the steering shaft 1 against rotation can be seen especially clearly from FIGS. 2 and 4:

In order to displace the locking bolt 2 axially out of the locking position of FIG. 2 in the direction of the arrow A into the release position of FIG. 4, the electric motor 13 is switched on so that its output shaft 26, via the worm 19, rotates the control disk 14 in the direction of the arrow B, and the pin 25 of the locking bolt 2 in the spiral groove 24 of the control disk 14 moves closer and closer to the axis of rotation (bearing bore 22) of the control disk 14. Simultaneously, the spiral rib 29 of the control disk 14 pivots the pivot lever 31 in the direction of the arrow C, out of the position shown in FIG. 2 into the position shown in FIG. 4, in order, via a slide 36 that is movable in the housing 6 parallel to the locking bolt 2, to switch off the electric switch 32 and then switch it on again, once the locking bolt 2 has reached its release position.

In order to displace the locking bolt 2 axially out of the release position of FIG. 4 in the direction of the arrow D into the locking position of FIG. 2, the electric motor 13 is switched on so that its output shaft 26, via the worm 19, rotates the control disk 14 in the direction of the arrow E, and the pin 25 of the locking bolt 2 moves farther and farther away in the spiral groove 24 of the control disk 14 from the axis of rotation (bearing bore 22) of the control disk 14. Simultaneously, the spiral rib 29 of the control disk 14 pivots the pivot lever 31 out of the position shown in FIG. 4 in the direction of the arrow F into the position shown in FIG. 2, in order via the slide 36 to switch the electric switch 32 off and then back on again once the locking bolt 2 has reached its locking position.

The two electric switches 32, 33 are connected to an electric or electronic control circuit with which, for instance, the electric motor 13, an optical and/or acoustic alarm device that becomes operative upon improper motion of the locking bolt 2 out of the locking position into the release position and/or improper motion of the locking bolt 2 out of the release position into the locking position, the ignition and/or the starter of the engine of the motor vehicle provided with the device for locking the steering shaft 1 against rotation etc. are controlled.

Modifications of the embodiment shown and described are certainly possible. For instance, the control disk 4 need not necessarily be driven with the aid of the worm 19; instead, a pinion driven by the electric motor 13 may also engage correspondingly configured circumferential teeth 18 of the control disk 14. The control disk 14 can also have, instead of the spiral groove 24, a protruding spiral rib for cooperating with the locking bolt 2, and/or instead of the protruding spiral rib 29, it can have a spiral groove for cooperating with the rotary position detector 17, or it can cooperate in a completely different way on the one side 15 with the locking bolt 2 and on the other side 16 with the rotary position detector 17. The rotary position detector 17 need not necessarily detect the two rotary positions of the control disk 14 that correspond to the locking position and to the release position of the locking bolt 2, but instead can detect any desired rotary position or rotary positions of the control disk 14. The rotary position detector 17 may also be constructed differently and comprise different components; for instance, in addition to or instead of one or more resetting switches, in particular microswitches, it may have one or more nonresetting switches or contactless switches (magnetic field sensors, in particular Hall sensors, photosensors, and so forth).

The control disk 14, which can be seen especially clearly in FIGS. 5 and 6, with the circumferential teeth 18 and the two flat surfaces 37, 38 extending parallel to one another on either side of the circumferential teeth 18, namely on the side 15 of the control disk 14 provided with the recessed spiral groove 24 and on the side 16 thereof provided with the protruding spiral rib 29, is relatively thin and therefore allows an especially compact configuration, which requires correspondingly little space, of the device for locking the steering shaft 1 against rotation as shown in FIGS. 1 through 4. The spacing of the printed circuit board 35 from the locking bolt 2 can be very slight and the housing 6 can be kept correspondingly slender.

The control disk 14 furthermore makes it possible to locate the electric motor 13 next to the locking bolt 2 so that its output shaft 26, with the worm 19 engaging the circumferential teeth 18 of the control disk 14, extends parallel to the locking bolt 2, which is likewise favorable with a view to the smallest possible dimensions of the housing 6 and thus of the device for locking the steering shaft 1 against rotation according to FIGS. 1 through 4.

1. In a device for locking the steering shaft of a motor vehicle against rotation by means of a locking bolt which cooperates with locking recesses of the steering shaft and which can be displaced back and forth between a locking position and a release position with the aid of a control member that can be rotated back and forth by an electric motor and which cooperates with a rotary position detector, the improvement wherein the control member comprises a circular control disk rotatable about an axis of rotation and which is arranged to cooperate on a first side with the locking bolt and a second side with the rotary position detector.

2. The improvement according to claim 1, wherein the control disk includes circumferential teeth arranged to engage a worm or pinion driven by the electric motor.

3. The improvement according to claim 1, wherein the locking bolt is displaceable back and forth radially relative to the axis of rotation of the control disk.

4. The improvement according to claim 2, wherein the locking bolt is displaceable back and forth radially relative to the axis of rotation of the control disk, and further wherein the electric motor is located next to the locking bolt, and the worm or pinion that engages the circumferential teeth of the control disk is secured to an output shaft of the electric motor, which shaft extends parallel to the locking bolt.

5. The improvement according to claim 3, wherein the first side of the control disk is adjacent to the locking bolt, and the control disk, on the first side thereof, has a spiral groove or a spiral rib, which cooperates with the locking bolt and winds around the axis of rotation of the control disk.

6. The improvement according to claim 1, wherein the second side of the control disk is adjacent to the rotary position detector, and the control disk on the second side thereof has a spiral rib or a spiral groove which cooperates with the rotary position detector and winds around the axis of rotation of the control disk.
